(19) United States
(12) Patent Application Publication
(10) Pub. No.: US 2009/0184642 A1
(43) Pub. Date: Jul. 23, 2009

(54) Plasma display panel having high clarity and color purity

(76) Inventor: Sung-Hune Yoo, Suwon-si (KR)

Correspondence Address: ROBERT E. BUSHNELL & LAW FIRM, 2029 K STREET NW, SUITE 600, WASHINGTON, DC, 20006-1004, US

(21) Appl. No.: 12/320,283

(22) Filed: Jan. 22, 2009

(30) Foreign Application Priority Data
Jan. 23, 2008 (KR) 10-2008-0007077

(51) Int. Cl. H01J 17/49; H01J 9/24

(52) U.S. Cl. 313/587; 313/582; 445/24

(57) ABSTRACT

A front dielectric layer and a PDP including the front dielectric layer are taught, and the PDP has a high degree of clarity and color purity obtained by preventing color temperature variance at various viewing angles. The front dielectric layer covers sustain electrodes arranged at predetermined intervals on a front substrate, wherein [(n₄₅₀/n′₄₅₀)−(n₅₅₀/n′₅₅₀)] is 0.01 or less, [(n₅₅₀/n′₅₅₀)−(n₆₃₀/n′₆₃₀)] is 0.01 or less, and [(n₄₅₀/n′₄₅₀)−(n₆₃₀/n′₆₃₀)] is 0.01 or less where n₄₅₀ is the refractive index of the front dielectric layer at a wavelength of 450 nm, n′₄₅₀ is the refractive index of the front substrate at a wavelength of 450 nm, n₅₅₀ is the refractive index of the front dielectric layer at a wavelength of 550 nm, n′₅₅₀ is the refractive index of the front substrate at a wavelength of 550 nm, n₆₃₀ is the refractive index of the front dielectric layer at a wavelength of 630 nm, and n′₆₃₀ is the refractive index of the front substrate at a wavelength of 630 nm.

### CLAIM OF PRIORITY

This application makes reference to, incorporates the same herein, and claims all benefits accruing under 35 U.S.C. § 119 from an application for PLASMA DISPLAY PANEL HAVING HIGH CLARITY AND COLOR PURITY earlier filed in the Korean Intellectual Property Office on 23 Jan. 2008 and there duly assigned Serial No. 10-2008-0007077.

### BACKGROUND OF THE INVENTION

1. Field of the Invention

The present invention relates to a plasma display panel (PDP), and more particularly to, a PDP having a high degree of clarity and color purity obtained by preventing color temperature variance at various viewing angles.

2. Description of the Related Art

Plasma display panels (PDPs) may be used for large screen displays, and have good display qualities because of the characteristics of self emission and quick response. PDPs may be formed in a thin configuration, and thus, for example, liquid crystal displays (LCDs) are suitable to be used as wall display devices.

In a PDP, a kind of gas is filled between two electrodes disposed in a sealed space and then a predetermined voltage is applied to the electrodes to cause a glow discharge in the sealed space, therefore, ultraviolet (UV) rays are generated. Phosphor layers, formed in a predetermined pattern, are excited by the generated UV rays and thus emitting visible light to form images.

According to driving methods, PDPs may be classified into direct current (DC)-type PDPs, alternating current (AC)-type PDPs, and hybrid-type PDPs. According to electrode structures, PDPs may also be classified into two-electrode type PDPs and three-electrode type PDPs. DC-type PDPs may include an auxiliary anode inducing an auxiliary discharge, and AC-type PDPs may include address electrodes increasing addressing speed by separately performing a selective discharge and a sustain discharge.

The AC-type PDPs may be further classified into PDPs having an opposing discharge-type electrode structure and PDPs having a surface discharge-type electrode structure, according to arrangements of electrodes. In PDPs having an opposing discharge-type electrode structure, two sustain electrodes which cause a discharge are respectively disposed on a front substrate and a rear substrate and the discharge occurs vertically to the substrates. In PDPs having a surface discharge-type electrode structure, two sustain electrodes which cause a discharge are disposed on the same substrate, and the discharge occurs on a surface of the substrate.

A contemporary PDP may include a front substrate, and sustain electrodes having a predetermined width and a predetermined height formed in pairs on a bottom surface of the front substrate, and each of the pairs of sustain electrodes includes a common electrode and a scan electrode.

A bus electrode to which a voltage is applied is formed on a bottom surface of each of the sustain electrodes. The sustain electrodes and the bus electrodes are covered by a front dielectric layer, and a protective layer is formed on a bottom surface of the front dielectric layer.

The rear substrate is disposed to face to the front substrate, and address electrodes having a predetermined width and height are formed on the rear substrate. The address electrodes are covered by a rear dielectric layer.

Also, barrier ribs defining discharge spaces and preventing crosstalk between adjacent discharge spaces are formed on the rear dielectric layer. The discharge spaces are filled with the discharge gas, and a phosphor layer formed of red, green, or blue phosphor is formed in each of the discharge spaces.

An AC voltage is applied between a first electrode and a second electrode, for example, a pair of sustain electrodes. When the AC voltage reaches a discharge firing voltage, an electric line of force is generated, thereby dissociating inert gas into electrons and ions. When electrons are recombined with ions, ultraviolet rays (UV) are generated and the phosphor is excited by the generated UV rays, thereby emitting light.

Visible light emitted from a phosphor is sequentially transmitted through the protective layer, which may be formed of MgO, the front dielectric layer, and the front substrate. The orientation of the visible light entering the top panel of the PDP at a predetermined incident angle may be changed according to the refractive index of each layer. In this regard, the refractive index of each layer changes according to a wavelength of the visible light. That is, the refractive index decreases as the wavelength increases. Therefore, when visible light having different colors incident to the front dielectric layer and the front substrate at a same angle of incidence, blue light is relatively strong when the displayed image is viewed by user located in front of the front substrate (i.e., near to a zero degree angle of incidence). When the user moves to a location away from the zero degree angle of incidence (i.e., a larger angle of incidence), red light becomes stronger, because blue light has a larger refractive index than red light in a same media. Therefore, the color temperature of a PDP may disadvantageously differs in accordance with a viewing angle of the user.

### SUMMARY OF THE INVENTION

It is therefore one object of the present invention to provide an improved PDP in order to overcome the color temperature difference as discussed above.

It is another object of the present invention to provide a PDP having a high degree of clarity and color purity, which is obtained by maintaining constant color temperature at different viewing angles.

According to an aspect of the present invention, there is provided a front dielectric layer for a PDP, covering sustain electrodes arranged at predetermined intervals on a front substrate, wherein [(n₄₅₀/n′₄₅₀)−(n₅₅₀/n′₅₅₀)] is 0.01 or less, [(n₅₅₀/n′₅₅₀)−(n₆₃₀/n′₆₃₀)] is 0.01 or less, and [(n₄₅₀/n′₄₅₀)−(n₆₃₀/n′₆₃₀)] is 0.01 or less, where n₄₅₀ is the refractive index of the front dielectric layer at a wavelength of 450 nm, n′₄₅₀ is the refractive index of the front substrate at a wavelength of 450 nm, n₅₅₀ is the refractive index of the front dielectric layer at a wavelength of 550 nm, n′₅₅₀ is the refractive index of the front substrate at a wavelength of 550 nm, n₆₃₀ is the refractive index of the front dielectric layer at a wavelength of 630 nm, and n′₆₃₀ is the refractive index of the front substrate at a wavelength of 630 nm.

The front dielectric layer may include three or more compounds selected from the group consisting of B₂O₃, SiO₂, PbO, BaO, TiO₂, and Al₂O₃.

The front dielectric layer may include three or more compounds selected from the group consisting of from 37 mole % to 43 mole % of B₂O₃, 10 mole % to 60 mole % of SiO₂, 15 mole % to 38 mole % of PbO, 0 mole % to 13 mole % of BaO, 0 mole % to 10 mole % of TiO₂, and 0 mole % to 8 mole % of Al₂O₃.

The front dielectric layer may include three or more compounds selected from the group consisting of B₂O₃, SiO₂, Bi₂O₃, ZnO, and Al₂O₃.

The front dielectric layer may include three or more compounds selected from the group consisting of 10 mole % to 40 mole % of B₂O₃, 10 mole % to 12 mole % of SiO₂, 8 mole % to 13 mole % of Bi₂O₃, 10 mole % to 35 mole % of ZnO, and 4 mole % to 13 mole % of Al₂O₃.

According to another aspect of the present invention, there is provided a plasma display panel including a front substrate on which sustain electrodes arranged at predetermined intervals are disposed; a front dielectric layer covering the sustain electrodes; a rear substrate disposed to face the front substrate, on which address electrodes extending in a direction perpendicular to a direction in which the sustain electrodes extend are disposed; a rear dielectric layer covering the address electrodes; barrier ribs defining discharge spaces between the front substrate and the rear substrate; and phosphor layers formed in the discharge spaces, wherein [(n₄₅/n′₄₅₀)−(n₅₅₀/n′₅₅₀)] is 0.01 or less, [(n₅₅₀/n′₅₅₀)−(n₆₃₀/n′₆₃₀)] is 0.01 or less, and [(n₄₅₀/n′₄₅₀)−(n₆₃₀/n′₆₃₀)] is 0.01 or less where n₄₅₀ is the refractive index of the front dielectric layer at a wavelength of 450 nm, n′₄₅₀ is the refractive index of the front substrate at a wavelength of 450 nm, n₅₅₀ is the refractive index of the front dielectric layer at a wavelength of 550 nm, n′₅₅₀ is the refractive index of the front substrate at a wavelength of 550 nm, n₆₃₀ is the refractive index of the front dielectric layer at a wavelength of 630 nm, and n′₆₃₀ is the refractive index of the front substrate at a wavelength of 630 nm.

The front dielectric layer may include three or more compounds selected from the group consisting of B₂O₃, SiO₂, PbO, BaO, TiO₂, and Al₂O₃.

The front dielectric layer may include three or more compounds selected from the group consisting of 37 mole % to 43 mole % of B₂O₃, 10 mole % to 60 mole % of SiO₂, 15 mole % to 38 mole % of PbO, 0 mole % to 13 mole % of BaO, 0 mole % to 10 mole % of TiO₂, and 0 mole % to 8 mole % of Al₂O₃.

The front dielectric layer may include three or more compounds selected from the group consisting of B₂O₃, SiO₂, Bi₂O₃, ZnO, and Al₂O₃.

The front dielectric layer may include three or more compounds selected from the group consisting of 10 mole % to 40 mole % of B₂O₃, 10 mole % to 12 mole % of SiO₂, 8 mole % to 13 mole % of Bi₂O₃, 10 mole % to 35 mole % of ZnO, and 4 mole % to 13 mole % of Al₂O₃.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a cross-sectional view of a part of a contemporary plasma display panel (PDP);

FIG. 2 is a cross-sectional view illustrating visible light refracted through a top panel of the contemporary PDP illustrated in FIG. 1;

FIG. 3A is a two dimensional graph of the difference between the difference in refractive indices of front dielectric layers and front substrates of the PDPs constructed as Examples 3, 4 and Comparative Examples 3, 4 at wavelengths of 450 nm and 550 nm with respect to a color temperature difference; and

FIG. 3B is a two dimensional graph of the difference between the difference in refractive indices of the front dielectric layers and the front substrates of the PDPs constructed as Examples 3, 4 and Comparative Examples 3, 4 at wavelengths of 450 nm and 630 nm with respect to a color temperature difference.

### DETAILED DESCRIPTION OF THE INVENTION

The present invention will now be described more fully with reference to the accompanying drawings, in which exemplary embodiments of the invention are shown.

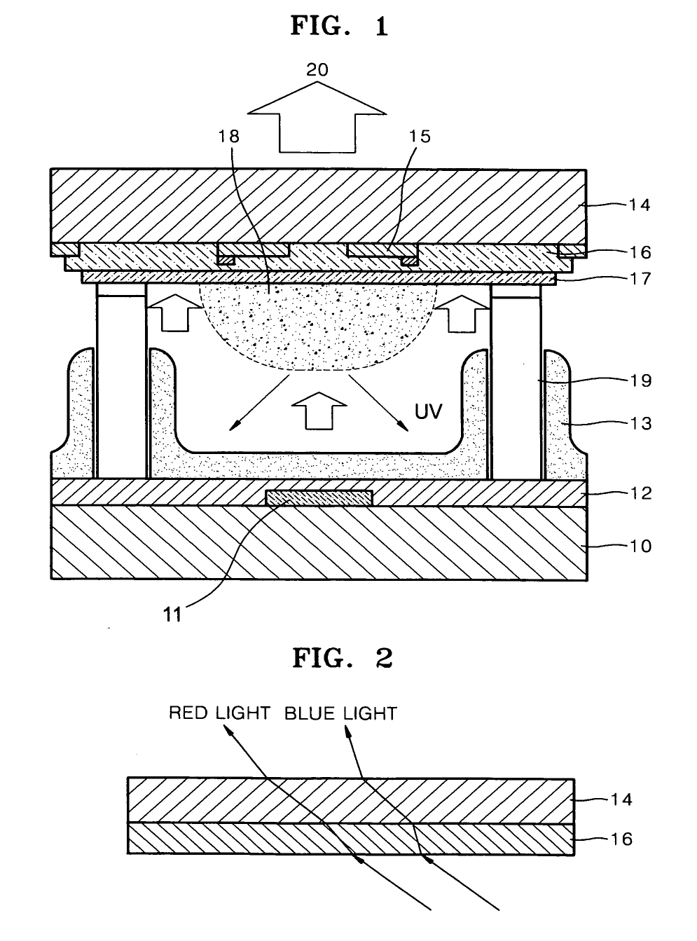

FIG. 1 is a cross-sectional view of apart of a contemporary plasma display panel (PDP);

Referring to FIG. 1, the contemporary PDP includes a front substrate 14, and sustain electrodes 15 having a predetermined width and a predetermined height formed in pairs on a bottom surface of front substrate 14, wherein each of the pairs of sustain electrodes 15 includes a common electrode and a scan electrode.

A bus electrode to which a voltage is applied is formed on a bottom surface of each of sustain electrodes 15. Sustain electrodes 15 and the bus electrodes are covered by a front dielectric layer 16, and a protective layer 17 is formed on a bottom surface of front dielectric layer 16.

Rear substrate 10 is disposed to face front substrate 14, and address electrodes 11 having a predetermined width and height are formed on rear substrate 10. Address electrodes 11 are covered by a rear dielectric layer 12.

Also, barrier ribs 19 defining discharge spaces and preventing crosstalk between adjacent discharge spaces are formed on rear dielectric layer 12. The discharge spaces are filled with discharge gas, and a phosphor layer 13 formed of red, green, or blue phosphor is formed in each of the discharge spaces.

Then, an AC voltage is applied between a first electrode and a second electrode, for example, a pair of sustain electrodes 15. When the AC voltage reaches a discharge firing voltage, an electric line of force is generated, thereby dissociating an inert gas into electrons and ions. When electrons are recombined with ions 18, ultraviolet rays (UV) are generated and the phosphor is excited by the generated UV rays and thus emitting light 20.

FIG. 2 is a cross-sectional view illustrating visible light refracted through a top panel of the contemporary PDP illustrated in FIG. 1.

Referring to FIGS. 1 and 2, visible light emitted from a phosphor is sequentially transmitted through protective layer 17, which may be formed of MgO, front dielectric layer 16, and front substrate 14. The orientation of the visible light entering the top panel of the PDP at a predetermined incident angle is changed according to the refractive index of each layer. In this regard, the refractive index of each layer changes according to a wavelength of the visible light. That is, the refractive index decreases as the wavelength increases. Therefore, when visible lights having different wavelength incidents front dielectric layer 16 and front substrate 14 at a same incident angle, blue light having relative short wavelength is relatively strong when viewed by the user in front of the front substrate (i.e., at approximately zero degree viewing angle with respect to the vertical line of the front substrate). As the user moves to a location away from the front of the front substrate (i.e., a larger viewing angle with respect to the vertical line of the front substrate), however, the red light becomes stronger, because blue light has a larger refractive index than red light. Thus, the color temperature of a PDP may differ according to a viewing angle.

According to the present invention, in a front dielectric layer for a PDP covering sustain electrodes arranged at predetermined intervals on a front substrate, a difference between the difference between the refractive index of the front dielectric layer at a first wavelength and the refractive index of the front substrate at the first wavelength, and the difference between the refractive index of the front dielectric layer at a second wavelength and the refractive index of the front substrate at the second wavelength may be 0.01 or less. For example, [(n₄₅₀/n′₄₅₀)−(n₅₅₀/n′₅₅₀)], [(n₅₅₀/n′₅₅₀)−(n₆₃₀/n′₆₃₀)], or [(n₄₅₀/n′₄₅₀)−(n₆₃₀/n′₆₃₀)] may be 0.01 or less, where n₄₅₀ is the refractive index of the front dielectric layer at a wavelength of 450 nm, n′₄₅₀ is the refractive index of the front substrate at a wavelength of 450 nm, n₅₅₀ is the refractive index of the front dielectric layer at a wavelength of 550 nm, n′₅₅₀ is the refractive index of the front substrate at a wavelength of 550 nm, n₆₃₀ is the refractive index of the front dielectric layer at a wavelength of 630 nm, and n′₆₃₀ is the refractive index of the front substrate at a wavelength of 630 nm.

The inventors of the present invention identified the relationship between a difference in refractive index difference and a color temperature difference at an interface between two types of materials (a front substrate for a PDP and a front dielectric layer for a PDP), using one kind of a front substrate and front dielectric layers having different refractive indexes from each other. Then, a difference between the refractive index of the front substrate and the refractive index of the front dielectric layer and a difference between color temperature were measured at wavelengths of 450 nm, 550 nm, and 630 nm.

As a result, the inventors found that the difference between the difference in refractive indices of the front dielectric layer and the front substrate at two wavelengths, that is, [(n₄₅₀/n′₄₅₀)−(n₅₅₀/n′₅₅₀)], [(n₅₅₀/n′₅₅₀)−(n₆₃₀/n′₆₃₀)], or [(n₄₅₀/n′₄₅₀)−(n₆₃₀/n′₆₃₀)] where n₄₅₀ is the refractive index of the front dielectric layer at 450 nm, n′₄₅₀ is the refractive index of the front substrate at 450 nm, n₅₅₀ is the refractive index of the front dielectric layer at 550 nm, n′₅₅₀ is the refractive index of the front substrate at 550 nm, n₆₃₀ is the refractive index of the front dielectric layer at 630 nm, and n′⁶³⁰ is the refractive index of the front substrate at 630 nm, increases linearly as the color temperature difference increases. That is, the difference between the difference in refractive indices of the front dielectric layer and the front substrate at two wavelengths has a linear proportional relationship with the color temperature difference. Meanwhile, as the color temperature difference increases, an image may be degraded due to differences in clarity and color purity at different viewing angles, because as the color temperature difference increases, colors are more distinctively distinguished from each other.

Such results, that is, the proportional relationship between the difference between the difference in refractive indices of the front dielectric layer and the front substrate at two wavelengths and the color temperature difference leads to the following interpretations. That is, as the difference between the difference in refractive indices of the front dielectric layer and the front substrate at two wavelengths increases, the color temperature difference increases and thus color temperature may vary and a degree of clarity and color purity may be degraded. In other words, as the difference between the difference in refractive indices of the front dielectric layer and the front substrate at two wavelengths decreases, the color temperature difference is decreased and thus the color temperature becomes uniform and a degree of clarity and color purity can be maintained constant at various viewing angles.

The inventors of the present invention found that when the color temperature difference of a PDP at various viewing angles is greater than 200K, colors are distinguished from each other and thus a degree of clarity and color purity are degraded; on the other hand, when the color temperature difference of a PDP at various viewing angles is 200K or less, colors cannot be distinguished from each other and thus a degree of clarity and color purity are maintained constant at various viewing angles. That is, 200K is a threshold value for determining whether the color temperature is uniform or non-uniform.

Since the difference between the difference in refractive indices of the front dielectric layer and the front substrate at two wavelengths has a linear proportional relationship with the color temperature difference, a difference between the difference in refractive indices of the front dielectric layer and the front substrate at two wavelengths corresponding to a specific color temperature difference value may be identified using a graph of the difference between the difference in refractive indices of the front dielectric layer and the front substrate at two wavelengths with respect to the color temperature difference.

In order to obtain a difference between the differences in refractive indices of the front dielectric layer and the front substrate at two wavelengths corresponding to a color temperature difference of 200K, a two dimensional graph having an x axis representing a difference between the difference in refractive indices of the front dielectric layer and the front substrate at two wavelengths and a y axis representing a color temperature difference is obtained. As a result, the difference between the differences in refractive indices of the front dielectric layer and the front substrate at two wavelengths corresponding to a color temperature difference of 200 K may be 0.01.

In other words, when the difference between the refractive index difference of the front substrate and the front dielectric layer at the first wavelength and the refractive index difference of the front substrate and the front dielectric layer at the second wavelength, that is, [(n₄₅₀/n′₄₅₀)−(n₅₅₀/n′₅₅₀)], [(n₅₅₀/n′₅₅₀)−(n₆₃₀/n′₆₃₀)] or [(n₄₅₀/n′₄₅₀)−(n₆₃₀/n′₆₃₀)] is 0.01 or less, the color temperature difference is 200K or less. Therefore, no color separation occurs and a decrease in a degree of clarity and color purity can be hindered.

The front dielectric layer used in the present invention may have any composition such that the difference between the refractive index difference of the front substrate and the front dielectric layer at the first wavelength and the difference between the refractive index difference of the front substrate and the front dielectric layer at the second wavelength is 0.01 or less. For example, the front dielectric layer may include three or more compounds selected from B₂O₃, SiO₂, PbO, BaO, TiO₂, and Al₂O₃.

Specifically, the front substrate is formed of glass, and the front dielectric layer may include three or more compounds selected from 37 mole % to 43 mole % of B₂O₃, 10 mole % to 60 mole % of SiO₂, 15 mole % to 38 mole % of PbO, 0 mole % to 13 mole % of BaO, 0 mole % to 10 mole % of TiO₂, and 0 mole % to 8 mole % of Al₂O₃. Within such ranges, the difference between the refractive index difference of the front substrate and the front dielectric layer at the first wavelength and the difference between the refractive index difference of the front substrate and the front dielectric layer at the second wavelength is 0.01 or less.

In other embodiments, the front dielectric layer may include three or more compounds selected from B₂O₃, SiO₂, Bi₂O₃, ZnO, and Al₂O₃.

Specifically, the front dielectric layer may include three or more compounds selected from 10 mole % to 40 mole % of B₂O₃, 0 mole % to 12 mole % of SiO₂, 8 mole % to 13 mole % of Bi₂O₃, 10 mole % to 35 mole % of ZnO, and 4 mole % to 13 mole % of Al₂O₃. Within such ranges, the difference between the refractive index difference of the front substrate and the front dielectric layer at the first wavelength and the difference between the refractive index difference of the front substrate and the front dielectric layer at the second wavelength is 0.01 or less.

A PDP according to an embodiment of the present invention includes a front substrate on which sustain electrodes arranged at predetermined intervals are disposed; a front dielectric layer covering the sustain electrodes; a rear substrate disposed to face the front substrate, on which address electrodes extending in a direction perpendicular to a direction in which the sustain electrodes extend are disposed; a rear dielectric layer covering the address electrodes; barrier ribs defining discharge spaces between the front substrate and the rear substrate; and phosphor layers formed in the discharge spaces, wherein [(n₄₅₀/n′₄₅₀)−(n₅₅₀/n′₅₅₀)], [(n₅₅₀/n′₅₅₀)−(n₆₃₀/n′₆₃₀)] and [(n₄₅₀/n′₄₅₀)−(n₆₃₀/n′₆₃₀)]is 0.01 or less where n₄₅₀ is the refractive index of the front dielectric layer at 450 nm, n′₄₅₀ is the refractive index of the front substrate at 450 nm, n₅₅₀ is the refractive index of the front dielectric layer at 550 nm, n′₅₅₀ is the refractive index of the front substrate at 550 nm, n₆₃₀ is the refractive index of the front dielectric layer at 630 nm, and n′₆₃₀ is the refractive index of the front substrate at 630 nm.

In the PDP according to the current embodiment, the front dielectric layer may have any composition such that the difference between the refractive index difference of the front substrate and the front dielectric layer at the first wavelength and the difference between the refractive index difference of the front substrate and the front dielectric layer at the second wavelength is 0.01 or less.

According to an embodiment of the present invention, the front dielectric layer of the PDP may include three or more compounds selected from B₂O₃, SiO₂, PbO, BaO, TiO₂ and Al₂O₃.

Specifically, the front dielectric layer of the PDP may include three or more compounds selected from 37 mole % to 43 mole % of B₂O₃, 10 mole % to 60 mole % of SiO₂, 15 mole % to 38 mole % of PbO, 0 mole % to 13 mole % of BaO, 0 mole % to 10 mole % of TiO₂, and 0 mole % to 8 mole % of Al₂O₃. Within such ranges, the difference between the refractive index difference of the front substrate and the front dielectric layer at the first wavelength and the difference between the refractive index difference of the front substrate and the front dielectric layer at the second wavelength is 0.01 or less.

Alternatively, the front dielectric layer of the PDP may include three or more compounds selected from B₂O₃, SiO₂, Bi₂O₃, ZnO, and Al₂O₃.

Specifically, the front dielectric layer may include three or more compounds selected from 10 mole % to 40 mole % of B₂O₃, 0 mole % to 12 mole % of SiO₂, 8 mole % to 13 mole % of Bi₂O₃, 10 mole % to 35 mole % of ZnO, and 4 mole % to 13 mole % of Al₂O₃. Within such ranges, the difference between the refractive index difference of the front substrate and the front dielectric layer at the first wavelength and the difference between the refractive index difference of the front substrate and the front dielectric layer at the second wavelength is 0.01 or less.

The present invention will be described in further details with reference to the following examples of a front dielectric layer for a PDP and a PDP including the front dielectric layer. These examples are for illustrative purposes only and are not intended to limit the scope of the present invention.

### EXAMPLES

### Preparation of Dielectric Slurry 1 (Bi-Based)

Ethylcellulose that acts as a binder was dissolved in a solvent mixture of butylcarbitolacetate and terpineol in a ratio of 3:7. Then, the resultant mixture was mixed with a glass composition including 13 mole % of Bi₂O₃, 12 mole % of SiO₂, 40 mole % of B₂O₃, and 35 mole % of ZnO to prepare a dielectric slurry 1 having a solid content of 75%.

### Preparation of Dielectric Slurry 2 (Pb-Based)

Ethylcellulose that acts as a binder was dissolved in a solvent mixture of butylcarbitolacetate and terpineol in a ratio of 3:7. Then, the resultant mixture was mixed with a glass composition including 35 mole % of PbO, 40 mole % of B₂O₃, and 25 mole % of SiO₂ to prepare a dielectric slurry 2 having a solid content of 75%.

### Example 1

### Preparation of Front Substrate 1 for PDP

Dielectric slurry 1 was coated on an electrode layer formed on a glass substrate to form a dielectric layer 1 having a thickness of 30 μm. Dielectric layer 1 was transparent.

A MgO protective layer was deposited on dielectric layer 1 using a physical vapor deposition (PVD) method, thereby completing the manufacture of a front substrate 1.

### Example 2

### Preparation of Front Substrate 2 for PDP

A front substrate 2 was manufactured in the same manner as in Example 1, except that dielectric slurry 2 was used instead of the dielectric slurry 1.

### Preparation of Rear Substrate

6 parts by weight of ethylcellulose that acts as a binder was mixed with 100 parts by weight of a solvent mixture of butylcarbitolacetate and terpineol in a mixture ratio of 3:7. Then, the resultant mixture was mixed with BaMgAl₁₀O₁₇:Eu that acts as a blue phosphor to prepare a phosphor slurry. The obtained phosphor slurry was coated on the inside surface of discharge cells defined by barrier ribs on a first substrate, and then the first substrate having the coated phosphor slurry was dried at 120° C. and sintered at 480° C. to form a blue phosphor layer.

Also, a (Y,Gd)BO₃:Eu phosphor layer and a ZnSiO₄:Mn phosphor layer were respectively formed in red and green discharge cells in the same manner as described above, thereby completing the manufacture of a rear substrate.

### Example 3

### Preparation of PDP 1

The rear substrate and the front substrate 1 were assembled to face each other and form a discharge space, the discharge space was vacuumed, a gas was injected into the discharge space, and then the structure was aged, thereby manufacturing a PDP 1.

### Example 4

### Preparation of PDP 2

A PDP 2 was manufactured in the same manner as in Example 3 except that the front substrate 2 was used instead of the front substrate 1.

### COMPARATIVE EXAMPLES

### Preparation of Dielectric Slurry 3

Ethylcellulose that acts as a binder was dissolved in a solvent mixture of butylcarbitolacetate and terpineol in a ratio of 3:7. Then, the resultant mixture was mixed with a glass composition including 27 mole % of PbO, 43 mole % of B₂O₃, and 30 mole % of BaO to prepare a dielectric slurry 3 having a solid content of 75%.

### Preparation of Dielectric Slurry 4

Ethylcellulose that acts as a binder was dissolved in a solvent mixture of butylcarbitolacetate and terpineol in a ratio of 3:7. Then, the resultant mixture was mixed with a glass composition including 14 mole % of Bi₂O₃, 52 mole % of B₂O₃, and 34 mole % of ZnO to prepare a dielectric slurry 4 having a solid content of 75%.

### Comparative Example 1

### Preparation of Front Substrate 3 for PDP

A front substrate 3 was prepared in the same manner as in Example 1, except that dielectric slurry 3 was used.

### Comparative Example 2

### Preparation of Front Substrate 4 for PDP

A front substrate 4 was prepared in the same manner as in Example 1, except that dielectric slurry 4 was used.

### Comparative Example 3

### Preparation of PDP 3

A PDP 3 was manufactured in the same manner as in Example 3, except that front substrate 3 was used.

### Comparative Example 4

### Preparation of PDP 4

A PDP 4 was manufactured in the same manner as in Example 3, except that front substrate 4 was used.

The difference between the refractive indexes of the front substrates 1 through 4 of the PDPs prepared according to Examples 1 and 2 and Comparative Examples 1 and 2 was measured at 450 nm, 550 nm, and 630 nm. The results are shown in Table 1 below.

The refractive indexes were measured using a contemporary refraction measurement method.

TABLE 1
Difference in refractive indexes for examples and
comparative examples

| Difference in | | | | |
|---|---|---|---|---|
| refractive | | | Comparative | Comparative |
| indexes | Example 1 | Example 2 | Example 1 | Example 2 |
| n₄₅₀/n′₄₅₀ | 1.152 | 1.129 | 1.190 | 1.167 |
| n₅₅₀/n′₅₅₀ | 1.147 | 1.125 | 1.178 | 1.158 |
| n₆₃₀/n′₆₃₀ | 1.145 | 1.123 | 1.167 | 1.154 |

Referring to Table 1, n₄₅₀, n₅₅₀, and n₆₃₀ respectively represent the refractive index of the front dielectric layer (dielectric layers 14) at 450 nm, 550 nm, and 630 nm, and n′₄₅₀, n′₅₅₀ and n′₆₃₀ respectively represent the refractive index of the front substrate (front substrates 1 through 4) at 450 nm, 550 nm, and 630 nm n.

The color temperature of the PDPs 1 through 4 including the front substrates 1 through 4 was measured to identify whether the color temperature is uniform or not. The results are shown in Table 2 below.

Whether the color temperature is uniform or not was able to be identified by measuring the color temperature of an image at various viewing angles and with the naked eye.

Also, the color temperature difference of the PDPs 1 through 4 at 450 nm and 550 nm and the color temperature difference of the PDPs 1 through 4 at 450 nm and 630 nm were measured.

The color temperature difference was measured using a contemporary color temperature measurement device and method.

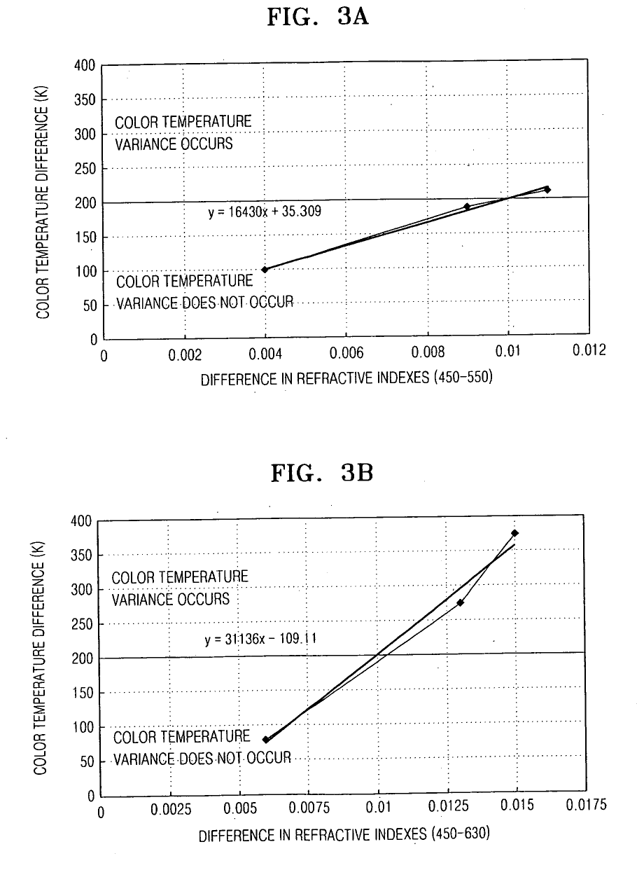

The relationship between the obtained color temperature difference values and corresponding refractive index difference values is shown in FIGS. 3 and 4. The refractive index differences are shown in Table 2 below. The measured values were rounded to three decimal places and are shown in Tables 1 and 2. Therefore, such data in Table 1 may not precisely correspond to Table 2.

TABLE 2
Difference in refractive index differences for examples and
comparative examples

| Difference in | | | | |
|---|---|---|---|---|
| refractive index | | | | |
| differences | | | | |
| at various | | | Comparative | Comparative |
| wavelengths | Example 3 | Example 4 | Example 3 | Example 4 |
| (n₄₅₀/n′₄₅₀) − | 0.004 | 0.004 | 0.011 | 0.009 |
| (n₅₅₀/n′₅₅₀) | | | | |
| (n₅₅₀/n′₅₅₀) − | 0.005 | 0.004 | 0.014 | 0.012 |
| (n₆₃₀/n′₆₃₀) | | | | |
| (n₄₅₀/n′₄₅₀) − | 0.006 | 0.006 | 0.016 | 0.013 |
| (n₆₃₀/n′₆₃₀) | | | | |
| Whether color | no | no | yes | yes |
| temperature | | | | |
| variance occurs | | | | |

The difference between the difference in refractive indices of front dielectric layers 1 and 2 and front substrates 1 and 2 of the PDPs 1 and 2 prepared according to Examples 3 and 4 at two wavelengths was 0.01 or less and the color temperature difference was 200 K or less. Therefore, color temperature variance did not occur. The difference between the difference in refractive indices of the front dielectric layers 3 and 4 and the front substrates 3 and 4 of the PDPs 3 and 4 prepared according to Comparative Examples 3 and 4 at two wavelengths was more than 0.01. Therefore, color temperature variance occurs.

Referring to FIGS. 3A and 3B, it may be seen that the difference between the difference in refractive indices of the front dielectric layer and the front substrate at two wavelengths corresponding to the color temperature difference of 200K is 0.01. In FIG. 3A, three points are achieved according to [(n₄₅₀/n′₄₅₀)−(n₅₅₀/n′₅₅₀)] as shown in Table 2 and the corresponding measured color temperature difference (K). In FIG. 3B, three points are achieved according to [(n₄₅₀/n′₄₅₀)−(n₆₃₀/n′₆₃₀)] as shown in Table 2 and the corresponding measured color temperature difference (K).

As described above, a degree of clarity and color purity may be maintained constant by adjusting the difference between the refractive index difference between a front substrate and a front dielectric layer at two wavelengths selected from 450 nm, 550 nm, and 630 nm to be 0.01 or less.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A plasma display panel (PDP), comprising:
a front substrate;
sustain electrodes arranged at predetermined intervals on the front substrate; and
a front dielectric layer covering the sustain electrodes arranged at predetermined intervals on the front substrate, with [(n₄₅₀/n′₄₅₀)−(n₅₅₀/n′₅₅₀)] being not more than 0.01, [(n₅₅₀/n′₅₅₀)−(n₆₃₀/n′₆₃₀)] being not more than 0.01, and [(n₄₅₀/n′₄₅₀)−(n₆₃₀/n′₆₃₀)] being not more than 0.01, where n₄₅₀ is a refractive index of the front dielectric layer at a wavelength of 450 nm, n′₄₅₀ is a refractive index of the front substrate at a wavelength of 450 nm, n₅₅₀ is a refractive index of the front dielectric layer at a wavelength of 550 nm, n′₅₅₀ is a refractive index of the front substrate at a wavelength of 550 nm, n₆₃₀ is a refractive index of the front dielectric layer at a wavelength of 630 nm, and n′₆₃₀ is a refractive index of the front substrate at a wavelength of 630 nm.

2. The plasma display panel (PDP) of claim 1, in which the front dielectric layer comprises not less than three compounds selected from a group consisting of B₂O₃, SiO₂, PbO, BaO, TiO₂, and Al₂O₃.

3. The plasma display panel (PDP) of claim 1, in which the front dielectric layer comprises three or more compounds selected from the group consisting of from 37 mole % to 43 mole % of B₂O₃, from 10 mole % to 60 mole % of SiO₂, from 15 mole % to 38 mole % of PbO, from 0 mole % to 13 mole % of BaO, from 0 mole % to 10 mole % of TiO₂, and from 0 mole % to 8 mole % of Al₂O₃.

4. The plasma display panel (PDP) of claim 1, in which the front dielectric layer comprises three or more compounds selected from a group consisting of B₂O₃, SiO₂, Bi₂O₃, ZnO, and Al₂O₃.

5. The plasma display panel (PDP) of claim 1, in which the front dielectric layer comprises three or more compounds selected from the group consisting of from 10 mole % to 40 mole % of B₂O₃, 0 mole % to 12 mole % of SiO₂, 8 mole % to 13 mole % of Bi₂O₃, 10 mole % to 35 mole % of ZnO, and 4 mole % to 13 mole % of Al₂O₃.

6. A plasma display panel, comprising:
a front substrate on which sustain electrodes arranged at predetermined intervals are disposed;
a front dielectric layer covering the sustain electrodes;
a rear substrate disposed to face the front substrate, on which address electrodes extending in a direction perpendicular to a direction in which the sustain electrodes extend are disposed;
barrier ribs defining discharge spaces between the front substrate and the rear substrate; and
phosphor layers formed in the discharge spaces, wherein [(n₄₅₀/n′₄₅₀)−(n₅₅₀/n′₅₅₀)] is not more than 0.01, [(n₅₅₀/n′₅₅₀)−(n₆₃₀/n′₆₃₀)] is not more than 0.01, and [(n₄₅₀/n′₄₅₀)−(n₆₃₀/n′₆₃₀)] is not more than 0.01, where n₄₅₀ is a refractive index of the front dielectric layer at a wavelength of 450 nm, n′₄₅₀ is a refractive index of the front substrate at a wavelength of 450 nm, n₅₅₀ is a refractive index of the front dielectric layer at a wavelength of 550 nm, n′₅₅₀ is a refractive index of the front substrate at a wavelength of 550 nm, n₆₃₀ is a refractive index of the front dielectric layer at a wavelength of 630 nm, and n′₆₃₀ is a refractive index of the front substrate at a wavelength of 630 nm.

7. The PDP of claim 6, in which the front dielectric layer comprises not less than three compounds selected from a group consisting of B₂O₃, SiO₂, PbO, BaO, TiO₂, and Al₂O₃.

8. The PDP of claim 6, in which the front dielectric layer comprises not less than three compounds selected from the group consisting of from 37 mole % to 43 mole % of B₂O₃, from 10 mole % to 60 mole % of SiO₂, from 15 mole % to 38 mole % of PbO, from 0 mole % to 13 mole % of BaO, from 0 mole % to 10 mole % of TiO₂, and from 0 mole % to 8 mole % of Al₂O₃.

9. The PDP of claim 6, in which the front dielectric layer comprises not less than three compounds selected from a group consisting of B₂O₃, SiO₂, Bi₂O₃, ZnO, and Al₂O₃.

10. The PDP of claim 6, in which the front dielectric layer comprises not less than three compounds selected from the group consisting of from 10 mole % to 40 mole % of B₂O₃, from 0 mole % to 12 mole % of SiO₂, from 8 mole % to 13 mole % of Bi₂O₃, from 10 mole % to 35 mole % of ZnO, and from 4 mole % to 13 mole % of Al₂O₃.

11. A method of manufacturing a plasma display panel (PDP), the method comprising:
preparing a front dielectric layer by coating a dielectric slurry on an electrode layer formed on a glass substrate, with the front dielectric layer covering sustain electrodes arranged at predetermined intervals on a front substrate, with [(n₄₅₀/n′₄₅₀)−(n₅₅₀/n′₅₅₀)] being not more than 0.01, [(n₅₅₀/n′₅₅₀)−(n₆₃₀/n′₆₃₀)] being not more than 0.01, and [(n₄₅₀/n′₄₅₀)−(n₆₃₀/n′₆₃₀)] being not more than 0.01, where n₄₅₀ is a refractive index of the front dielectric layer at a wavelength of 450 nm, n′₄₅₀ is a refractive index of the front substrate at a wavelength of 450 nm, n₅₅₀ is a refractive index of the front dielectric layer at a wavelength of 550 nm, n′₅₅₀ is a refractive index of the front substrate at a wavelength of 550 nm, n₆₃₀ is a refractive index of the front dielectric layer at a wavelength of 630 nm, and n′₆₃₀ is a refractive index of the front substrate at a wavelength of 630 nm;
preparing the front substrate by depositing a protective layer on the prepared front dielectric layer;
preparing a rear dielectric layer by coating a phosphor slurry on an internal surface of discharge cells;
preparing a rear substrate by depositing phosphor layers on the prepared rear dielectric layer; and
assembling the prepared rear substrate and the front substrate to face to each other and to be spaced apart from each other, and filling gas into the discharge cells vacuumed.

12. The method of claim 11, in which the front dielectric layer comprises not less than three compounds selected from a group consisting of B₂O₃, SiO₂, PbO, BaO, TiO₂, and Al₂O₃.

13. The method of claim 11, in which the front dielectric layer comprises three or more compounds selected from the group consisting of from 37 mole % to 43 mole % of B₂O₃, from 10 mole % to 60 mole % of SiO₂, from 15 mole % to 38 mole % of PbO, from 0 mole % to 13 mole % of BaO, from 0 mole % to 10 mole % of TiO₂, and from 0 mole % to 8 mole % of Al₂O₃.

14. The method of claim 11, in which the front dielectric layer comprises three or more compounds selected from a group consisting of B₂O₃, SiO₂, Bi₂O₃, ZnO, and Al₂O₃.

15. The method of claim 11, in which the front dielectric layer comprises three or more compounds selected from the group consisting of from 10 mole % to 40 mole % of B₂O₃, 0 mole % to 12 mole % of SiO₂, 8 mole % to 13 mole % of Bi₂O₃, 10 mole % to 35 mole % of ZnO, and 4 mole % to 13 mole % of Al₂O₃.
